(19) United States
(12) Patent Application Publication
(10) Pub. No.: US 2002/0128833 A1
(43) Pub. Date: Sep. 12, 2002

(54) METHOD OF DISPLAYING WORDS DEPENDENT ON ARELIABILITY VALUE DERIVED FROM A LANGUAGE MODEL FOR SPEECH

(76) Inventor: VOLKER STEINBISS, AACHEN (DE)

Correspondence Address: CORPORATE PATENT COUNSEL, US PHILIPS CORPORATION, 580 WHITE PLAINS ROAD, TARRYTOWN, NY, 10591

(21) Appl. No.: 09/307,979

(22) Filed: May 10, 1999

(30) Foreign Application Priority Data
May 13, 1998 (DE) 19821422.7

(51) Int. Cl. G10L 15/26

(52) U.S. Cl. 704/235

(57) ABSTRACT

Errors occur in some of the recognized words in dictation systems in which the individual words of a text are recognized from a spoken text and displayed, which errors are to be corrected by an operator on the basis of the displayed text. To ascertain more quickly which words are most likely in need of correction, it is suggested according to the invention to determine reliability values for the words, and to display the words in a manner which is dependent on these reliability values. This display may involve, for example, different grey tones, different colors, different letter types, or underlining. It is practical to compare the reliability values with threshold values and to display in a different manner from the remaining text only those words whose reliability values lie below the threshold value or below certain threshold values.

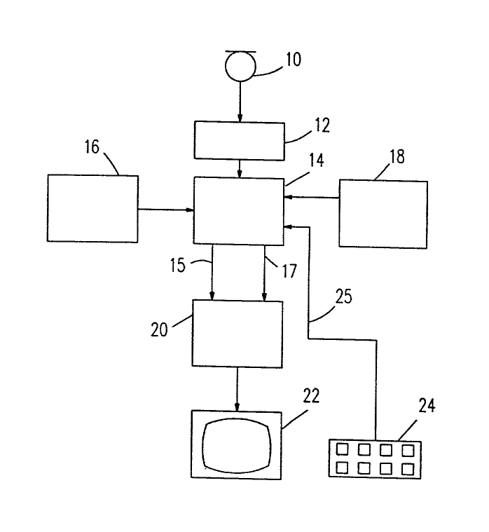

The invention relates to a method of displaying words derived from a speech signal input on a display device, a reliability value being formed for each word.

Such methods are known in so-called dictation systems in which the words derived from the speech signal are displayed on a screen. Direct printing of the text derived from the dictation is usually not practicable, because too many errors occur in the systems known at present, which errors have to be corrected first on the basis of the text shown on the screen. To achieve this, an operator must read through the displayed text carefully, possibly while listing to the spoken, recorded text, i.e. the speech signal, in order to determine and correct any words which were imperfectly recognized by the system. This requires a considerable amount of time, which partly cancels out the time gain achieved by the automatic conversion of the spoken text into the displayed text.

It is an object of the invention to provide a method of the kind mentioned in the opening paragraph which renders possible a simpler and faster correction of the text consisting of the displayed words.

According to the invention, this object is achieved in that the words are displayed in a different manner in dependence on the reliability value.

The determination of a reliability value for each word derived from a speech signal is known from ICASSP 1995, vol. I, pp. 297-300, and serves various purposes, for example to determine whether a word derived from the speech signal is to be accepted or rejected in information systems, in particular those in which a dialogue is held. In fact, the reliability value also is a measure for the degree of certainty with which a word was recognized, i.e. in particular how well the recognized word corresponds to an acoustic model stored in the system and, if a language model is used, with what probabiity this word might occur in the position in a word sequence as recognized. According to the invention, the reliability value is now used for displaying the probability that a spoken word in the text was incorrectly determined. An optical accentuation of words having a low reliability value during the correction process renders it possible for an operator to ascertain quickly which words were possibly incorrectly recognized, so that these can then be corrected more quickly.

The display of the words in dependence on the reliability value may take place in various ways. One possibility is to display the words with a grey tone which depends on the reliability value. Another possibility is to change the color of the displayed word in dependence on the reliability value. The words may also be displayed against different backgrounds, in different letter types, or underlined, in dependence on the reliability value. The expression “letter type” here in general covers different shapes of letters, bold type, italics, or any other deviating letter forms. A combination of individual possibilities may also be used, for example, words having a very low reliability value may be displayed not only with a different grey tone or different color, but also underlined.

The distinguishing display may take place, for example, so as to be proportional to the reliability value. It is practicable, however, especially in the display by means of different letter types or underlinings, when at least one threshold value is provided for the reliability value, and the display takes place in dependence on whether the threshold value or one of the threshold values is exceeded in downward direction. Words determined with a sufficiently high reliability value, above the (highest) threshold value, are then displayed normally, while only words with reliability values below the or a threshold value are displayed in a different manner. Such words can then be recognized even more quickly, so that a correction of these words, if necessary, is made even easier.

It may be useful here when the threshold value or the threshold values is/are changeable. Such a change in the threshold values may be effected by the operator, for example if the latter recognizes that unnecessarily many words which were correctly recognized are displayed in a different manner. Such a change may also be carried out automatically by the system when many words which were differently displayed on account of an only slightly reduced reliability value are nevertheless characterized as correct by the operator.

The correction of a displayed text is carried out in general in that a cursor is automatically put on the consecutive words of the text, possibly in parallel with a reproduction of the stored speech signal from which these words were derived. The cursor can be stopped, in particular at a word which is differently displayed, for example in that a key is operated, so as to correct this word if the operator recognizes it as incorrect. There are also systems which not only determine a word from each spoken word and display it, but also provide alternative words for single words or complete alternative sentences, as is known from EP 0 614 172 A2, in which case it is useful when such alternative words are automatically displayed adjacent the words where the cursor is stopped, preferably in the order of their reliability values. A correction can then be carried out even more quickly.

The invention further relates to a device for displaying words derived from an acoustic speech signal input on a display device, with a processing device for receiving the acoustic speech signal and for supplying data which represent words derived from said signal and associated reliability values, and with a control device for converting said data into control signals for the display device.

The purpose being to recognize the possibly incorrectly recognized words from among the words displayed on the display device more quickly in such an arrangement, the invention is furthermore characterized in that the data representing the reliability values are supplied to the control device for the purpose of changing the control signals to the display device generated for the associated words.

The data which represent the letters of the recognized words are usually 8-bit data words. These are supplied to a control device, which converts the data words into control signals, for example for a picture tube, so as to display the words as a legible text. The control device for this purpose receives additional control commands, which indicate in what way the text is to be displayed, for example in what type size, what letter type, what color, etc. The reliability values supplied to the control device, or data derived therefrom, are then supplied to the control device as additional control commands for determining how the words are to be displayed.

An example of embodiment of the invention will be explained in more detail below with reference to the drawing. In the drawing, an acoustically provided speech signal is converted into an electric signal by a microphone 10 and subsequently applied to a preprocessing unit 12 which converts the electric signal into a sequence of test signals which characterize the speech signal. These test signals are supplied to a processing device 14, which also receives reference signals from a memory 16, so as to carry out a comparison between each test signal and a number of reference signals. Words are determined from the similarity between certain sequences of reference signals and the sequence of test signals, for which in general language model values from a further memory 18 are used, said words being defined by the sequences of reference signals in the memory 16.

These words, or the letters of these words, are consecutively supplied on the line 15 to a control device 20. This device is tuned by means of control commands, which were preferably supplied previously to the control device in a manner not shown, such that it converts the data signals on the line 15 into control signals for preferably a picture tube 22.

In addition, reliability values are formed for the individual words in the comparison of the reference signals from the memory 16 with the test signals in the processing device 14, possibly also with the use of language model signals from the memory 18, which values are also supplied to the control device 20 via a line 17. Said reliability values here operate in a manner similar to that of the control commands mentioned above, i.e. they influence the control unit 20 in the generation of control signals for the picture tube 22, so that the words are displayed in a manner dependent on their reliability values. The reliability values may then, for example, also be compared with one or several threshold values in the processing device 14, so that only signals are transmitted over the line 17 which indicate whether the reliability value of the relevant word lies above or below certain threshold values. Commands can be transmitted to the processing device 14 via an input device 24, for example a keyboard, which commands are capable of changing the threshold values. In addition, correction values for words not correctly derived from the speech signal are put in also by means of this input device 24. Control commands can also be transmitted via this input device 24, which delete the display of alternative words for a given display word and select one of these alternatives.

1. A method of displaying words derived from a speech signal input on a display device, a reliability value being formed for each word, characterized in that the words are displayed in a different manner in dependence on their respective reliability values.

2. A method as claimed in claim 1, characterized in that the words are displayed in a grey tone which depends on the reliability value.

3. A method as claimed in claim 1, characterized in that the words are displayed in a color which depends on the reliability value.

4. A method as claimed in claim 1, characterized in that the words are displayed in a letteer type which depends on the reliability value.

5. A method as claimed in claim 1, characterized in that the words are displayed underlined in dependence on the reliability value.

6. A method as claimed in claim 1, characterized in that the words are displayed against a background which depends on the reliability value.

7. A method as claimed in any one of the claims 1 to 6, characterized in that at least one threshold value is provided for the reliability value, and the display takes place in dependence on whether the threshold value or one of the threshold values is exceeded in downward direction.

8. A method as claimed in claim 7, characterized in that the threshold value(s) is/are changeable.

9. A method as claimed in claim 7 or 8, in which alternative words of lower reliability value are generated from the speech signal for at least some words, characterized in that at least one alternative word for a word whose reliability value lies below at least one threshold value is displayed upon the input of a command and is inserted so as to replace the originally displayed word upon the input of a further command.

10. A device for displaying words derived from an acoustic speech signal input on a display device, with
a processing device (12, 14, 16, 18) for receiving the acoustic speech signal and for supplying data which represent words derived from said signal as well as associated reliability values,
a control device (20) for converting the data into control signals for the display device (22),
characterized in that the data representing the reliability values are supplied to the control device (20) for the purpose of changing the control signals corresponding to the relevant words for the display device (22).
